(19) United States
(12) Patent Application Publication
(10) Pub. No.: US 2018/0121569 A1
(43) Pub. Date: May 3, 2018

(54) DEVICE DESIGN RECEIVING SYSTEM

(71) Applicant: HITACHI, LTD., Tokyo (JP)

(72) Inventors: Futoshi FURUTA, Tokyo (JP); Nobuyuki SUGII, Tokyo (JP); Daisuke RYUZAKI, Tokyo (JP)

(21) Appl. No.: 15/785,813

(22) Filed: Oct. 17, 2017

(30) Foreign Application Priority Data
Oct. 28, 2016 (JP) 2016-211507

(51) Int. Cl. G06F 17/50

(52) U.S. Cl. CPC G06F 17/50; G06F 2217/04; G06F 2217/06; G06F 2217/12

(57) ABSTRACT

A customer's request is more appropriately reflected in the design. A method of processing a request for designing a device receives a required specification for a device from a user input and output device, searches a case similar to the required specification in the old case specification information, outputs the case similar to the required specification found in the old case specification information to the user input and output device, and calculates a specification of a design result of the device according to the required specification for an unauthorized input for the similar case from the user input and output device, or transmits a request for designing the device according to the required specification to an external design system, and outputs the design result of the device calculated or received from the design system to the user input and output device.

### CLAIM OF PRIORITY

The present application claims priority from Japanese patent application JP 2016-211507 filed on Oct. 28, 2016, the content of which is hereby incorporated by reference into this application.

### TECHNICAL FIELD

The present invention relates to a device design receiving system.

### BACKGROUND ART

In general, performances (for example, bandwidth) of ready-made devices (for example, sensors) are set discretely, taking into consideration the burden of design and manufacture at a manufacturer, and multiple parts cover a wide range. A customer selects an already-made device close to a desired specification from the ready-made devices having discrete performances which have been designed and manufactured by the manufacturer. For that reason, the performance of the device does not necessarily match the customer's requirement.

Meanwhile, prototyping servicers including design and manufacture which can provide prototypes to the customers in a customized manner and promptly, such as a service using a 3D printer, are on the way, and it is conceivable that similar services are provided for various devices. For example, an environment in which with the application of the principle of the 3D printer to MEMS (Micro Electro Mechanical Systems), sensor can be fabricated with a short TAT (Turnaround Time) and evaluated instantaneously is in place.

In the case of the customized manner, since the sensor performance meets the individual customer's requirement, as prototyping cases are accumulated, the lineup will become more continuous as compared with ready-made parts. The customer can select the design and manufacture according to his required performance, and in a situation where prototyping cases are accumulated, prototyping can be performed with less correction.

As a prior document relating to the present disclosure, there is Japanese Unexamined Patent Application Publication No. 2011-221792. Japanese Unexamined Patent Application Publication No. 2011-221792, discloses that “a specification determination system 1 for determining the specification of a product including at least one component that is an element for satisfying a demand includes a storage unit 3 that stores past specification records including past specifications determined according to past demands, and information on delivery dates and prices of past specifications, and component information in which each component is associated with the information on the delivery date and price of each component; an estimation unit 21 that estimates a delivery date and price of a new specification on the basis of the component information and a new specification that is a specification that satisfies a new demand; and a presentation unit 23 that comparably presents new specification information including the new specification and the delivery date and price of the new specification, and the past specification record that matches a predetermined comparison condition read from the storage unit 3, and presents the new specification information that has been changed in addition to the new specification information that has not yet been changed when the new specification information has been changed.” (Abstract).

### CITATION LIST

### Patent Literature

Patent Literature 1: Japanese Unexamined Patent Application Publication No. 2011-221792

### SUMMARY OF INVENTION

### Solution to Problem

In the manufacture of the customized prototypes, a customer's initial request is not always clear. In addition, the customer's request may change during a progress from a request time toward designing and manufacturing. In other words, when the process progresses to some extent in each of a designing stage and a manufacturing stage, a change occurs from an initial requirement specification (performance and shape). Also, even during a stage in which the requirement specification has not yet been reached, if there is information that the cost and delivery date which have initially been presented can be reduced, there is the possibility of proceeding (compromise) to a next stage at that time. Therefore, in the service providing the customized prototype to the customer, a mechanism in which the customer's request is more appropriately reflected is desired.

### Solution to Problem

A typical example is a device design receiving system that receives a request for designing a device, which includes old case specification information indicating a specification of an old case of a device design; a receiving unit that receives a required specification for a device from a user input and output device; a search unit that searches a case similar to the required specification in the old case specification information; an output unit that outputs the case similar to the required specification found in the old case specification information to the user input and output device; and a design interface unit that calculates a specification of a design result of the device according to the required specification for an unauthorized input for the similar case from the user input and output device, or transmits a request for designing the device according to the required specification to an external design system, and outputs the design result of the device calculated or received from the design system to the user input and output device.

### Advantageous Effects of Invention

According to a representative embodiment of the present invention, the customer's request can be more appropriately reflected in the service of providing the customized prototype to the customer. The problems, configurations, and effects other than those described above will be clarified by the following description of embodiments.

### BRIEF DESCRIPTION OF DRAWINGS

FIG. 1 illustrates a configuration example of a prototype service system.

FIG. 2 illustrates a request level input page.

FIG. 3 Illustrates a beginner level consultation input page.

FIG. 4 illustrates a CAD input page.

FIG. 5 illustrates an estimate output and approval input page.

FIG. 6 illustrates a required specification input page.

FIG. 7 illustrates a prototype candidate selection page.

FIG. 8 illustrates a prototype candidate selection page.

FIG. 9 schematically illustrates a design provisional specification output and approval input page.

FIG. 10 schematically illustrates a manufacturing provisional specification output and approval input page.

FIG. 11 illustrates an evaluation result output page.

FIG. 12 illustrates another example of the required specification input page.

FIG. 13 illustrates another example of the prototype candidate selection page.

FIG. 14 illustrates another example of the design provisional specification output and approval input page.

FIG. 15A illustrates a configuration example of a reception control program stored, in a prototype receiving server.

FIG. 15B illustrates an example of a database stored by the prototype receiving server.

FIG. 16 illustrates a configuration example of an old case specification database.

FIG. 17 illustrates a configuration example of a ready-made product specification database.

FIG. 18 illustrates a data flow in the determination of a request level (customer level) and a laser interface at a beginner level.

FIG. 19 illustrates a data flowchart of a prototype flow at an advanced level.

FIG. 20A illustrates a data flowchart of a prototype flow at an intermediate level.

FIG. 20B illustrates a data flowchart of the prototype flow at the intermediate level.

FIG. 20C illustrates a data flowchart of the prototype flow at the intermediate level.

FIG. 20D illustrates a data flowchart of the prototype flow at the intermediate level.

FIG. 21 illustrates a configuration example of a required specification database.

FIG. 22 illustrates a configuration example of a similarity specification record of an old case.

FIG. 23 illustrates a configuration example of a similarity specification record of a ready-made product.

FIG. 24 illustrates a configuration example of a candidate specification database.

### DESCRIPTION OF EMBODIMENTS

Embodiments of the present invention will be described below with reference to the accompanying drawings, and it should be noted that the present embodiment is merely an example for realizing the present invention and does not limit the technical scope of the present invention. In the drawings, the same reference numerals denote identical configurations.

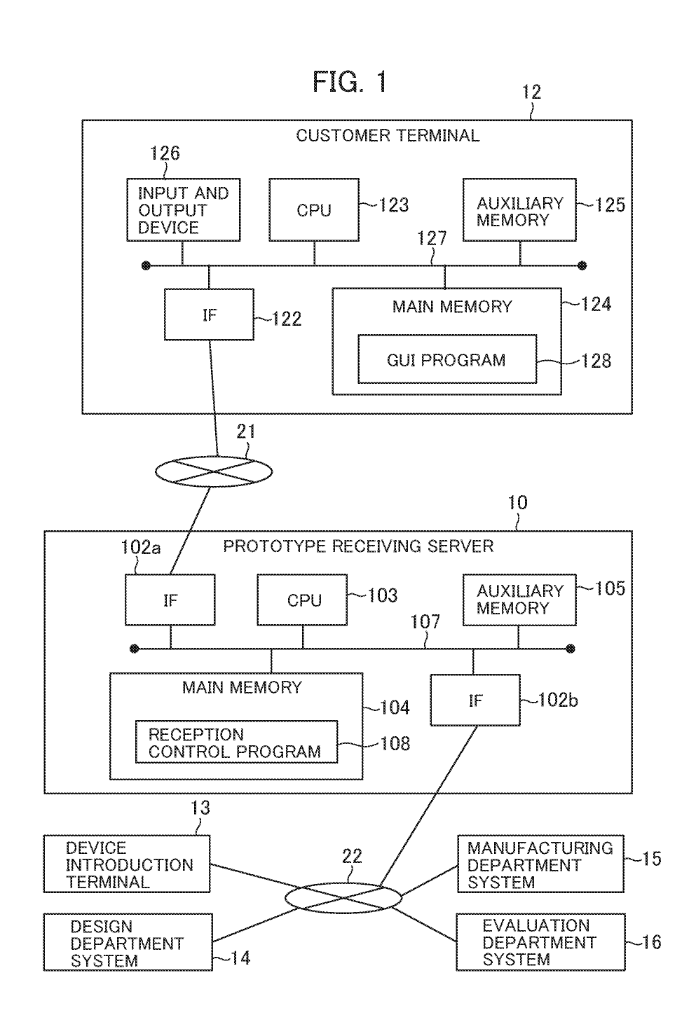

FIG. 1 illustrates a configuration example of a prototype service system according to the present embodiment. The prototype service system includes a prototype receiving server 10, a customer terminal 12, a device introduction terminal 13, a design department system 14, a manufacturing department system 15, and an evaluation department system 16.

The customer terminal 12 (and its input and output device) is a user input and output device and communicates with the prototype receiving server 10 over a network 21. The network 21 is the Internet. The prototype receiving server 10 communicates with the device introduction terminal 13, the design department system 14, the manufacturing department system 15, and the evaluation department system 16 over the network 22. The network 22 is, for example, a local area network. The types of the networks 21 and 22 Is optional,

A customer who requests a prototype of the device accesses the prototype receiving server 10 with the use of the customer terminal 12. The customer includes an input person (operator of the system) for inputting the customer's required specification instead. The customer terminal 12 presents information to the elastomer and accepts an input from the customer by the aid of a GUI (Graphical User Interface). The customer terminal 12 transmits the customer's request to the prototype production receiving server 10, receives information on each step (design, manufacturing, and evaluation) of a prototype flow from the prototype; receiving server 10 and presents the received information to the customer. The customer may use an input and output device directly connected to the prototype receiving server 10 as the input and output device instead of the customer terminal 12.

The prototype receiving server 10 functions as an interface of the prototype service system 10. The prototype receiving server 10 cooperates with the device introduction terminal 13, the design department system 14, the manufacturing department system 15, and the evaluation department system 16 to present information and problems that become evident at a design or prototype level to the customer, and accepts specification changes according to new requests from the customer.

The device introduction terminal 13 is a terminal used by a service operator, and the design department system 14, the manufacturing department system 15, and the evaluation department system 16 are computer systems of the respective departments.

The prototype receiving server 10 can provide customers with a one stop service of the prototype of the device from design to evaluation. In addition, the prototype receiving server 10 appropriately reflects the customer's changing request in the design and manufacture of the prototype, and can provide the customer with a material for determining whether the current specification satisfies the customer's request, or not. The prototype receiving server 10 can promptly convert the required specification into the design specification and quickly respond to a change in the specification.

The prototype receiving server 10 has, for example, a computer configuration. The prototype receiving server 10 includes a CPU (Central Processing Unit) 103, a main memory 104 for storing data (including a program) necessary for the CPU 103 to execute processing, and an auxiliary memory 105 such as a hard disk or a flash memory having a capacity to store a large amount of data.

The prototype receiving server 10 further includes IFs (interfaces) 102a and 102b for communicating with other devices, and a communication path 107 that connects those devices to each other. The CPU 103 as a processor operates as a function unit, that executes the program stored in the main memory 104 to realize a predetermined function. Specifically, the CPU 103 provides the prototype receiving service with the execution of the reception control program 108.

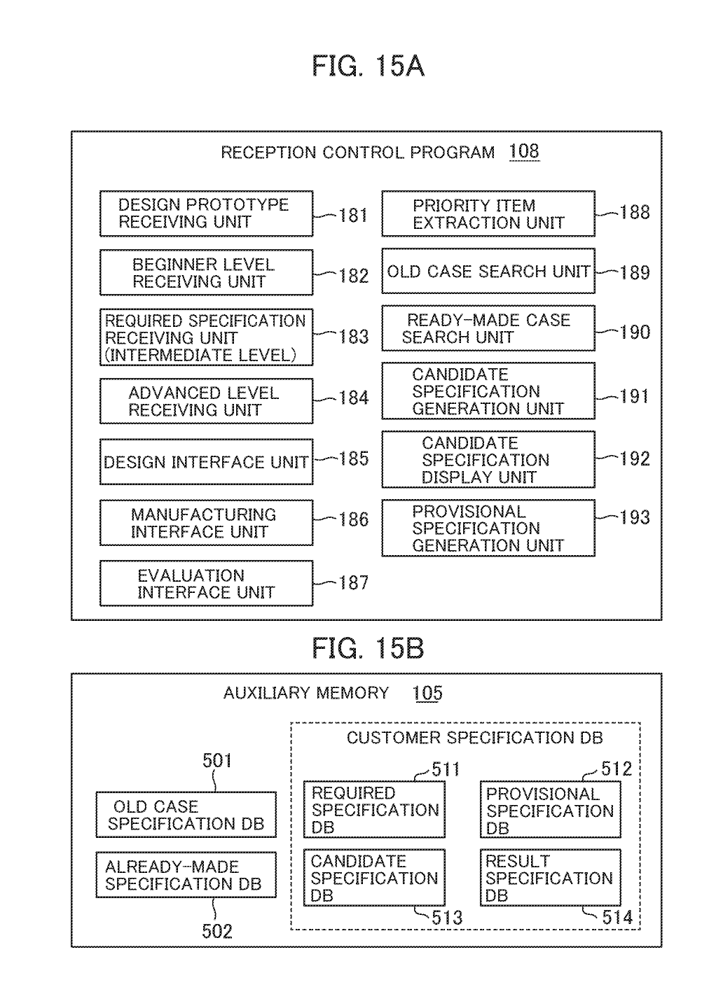

A configuration of the reception control program 108 will be described later with reference to FIG. 15A, The auxiliary memory 105 stores data (information) used by the CPU 103. An example of interrelation stored in the auxiliary memory 105 will be described with reference to FIG. 15B.

The program and data may be stored in advance in the main memory 104 or the auxiliary memory 105 including a non-transitory storage medium, or may be installed (loaded) from another device through the IFs 102a and 102b when necessary. The main memory 104 and the auxiliary memory 105 configure a memory, individually or integrally. The same is applied to other computers.

The customer terminal 12 has, for example, a computer configuration. The customer terminal 12 includes a CPU 123, a main memory 124 for storing data (including a program) necessary for the CPU 123 to execute processing, and an auxiliary memory 125 such as a hard disk or a flash memory having a capacity to store a large amount of data.

The customer terminal 12 further includes an IF 122 for communicating with another device, an input and output device 126 for inputting and outputting a keyboard, a display, and the like, and a communication path 127 that connects those devices to each other.

The CPU 123 provides a GUI for the prototype of the device to the customer with the execution of a GUI program (for example, Web browser) 128. The auxiliary memory 105 stores data (information) used by the CPU 123, The input and output device 126 includes, for example, an input device such as a mouse and a keyboard, and an output device such as a display and a printer.

For example, the device introduction terminal 13 is configured by a computer like the elastomer terminal 12, and the design department system 14, the manufacturing department system 15, and the evaluation department system 16 are configured by one or more computers.

Hereinafter, an example of a prototype service system that can provide a prototype of a MEMS (Micro Electro Mechanical Systems) sensor to the customer in a customized manner (continuous specifications) and quickly, as with a prototype service using a 3D printer will be described.

First, in the prototype flow, an example of GUI pages displayed on the customer terminal 12 and the transition of the GUI pages will be described. The prototype receiving server 10 generates the respective GUI pages according to a request from the customer terminal 12 and information from the department systems, and transmits the generated GUI pages to the customer terminal 12.

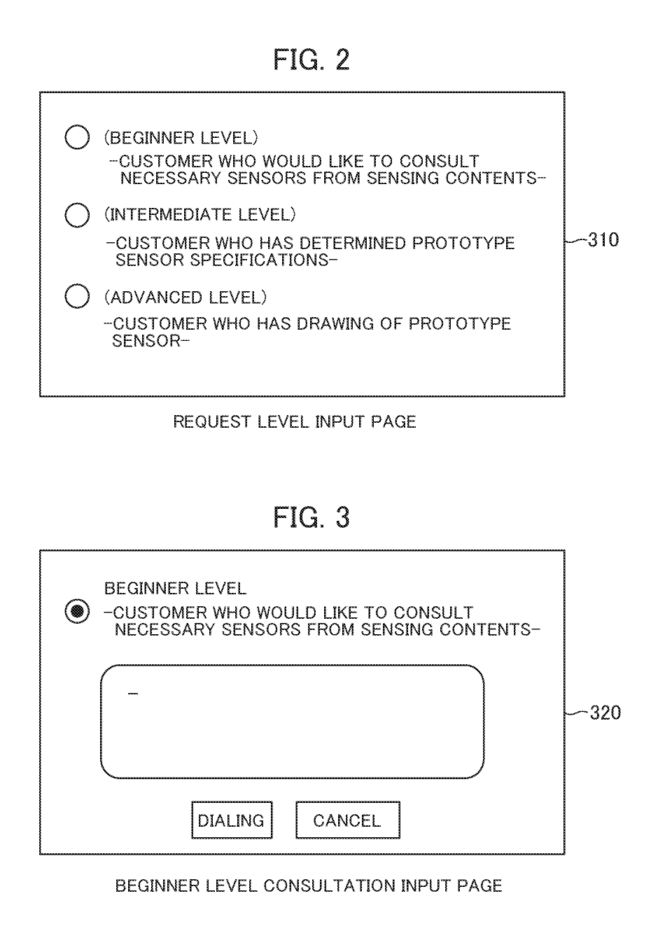

The customer terminal 12. (GUI program 128) first displays a request level input page 310 exemplified in FIG. 2 on the input and output device 126. The customer selects his request level in a request level input page 310. In the example of FIG. 2, one level is selected from a beginner level, an intermediate level, and an advanced level.

The beginner level is a level at which the customer does not know what to measure and how to measure. The intermediate level is a level at which the customer can see what to measure with which specification, but cannot design or produce sensors or systems. The advanced level is a level at which the customer are an expert of the sensors and can produce design drawings (CAD diagrams). As described below, with the preparation of interfaces according to the level of the customers, appropriate services can be provided according to a difference in the level of the customers.

When the beginner level is selected in the request level input page 310, the customer terminal 12 displays a beginner level consultation input page 320 exemplified in FIG. 3. The beginner level consultation input page 320 includes a dialog box for entering the contents of consultation, and causes the customer to fill a consultation case in the dialog box. The customer fills, for example, a sensing requirement (what to do with the sensor) in the dialog box.

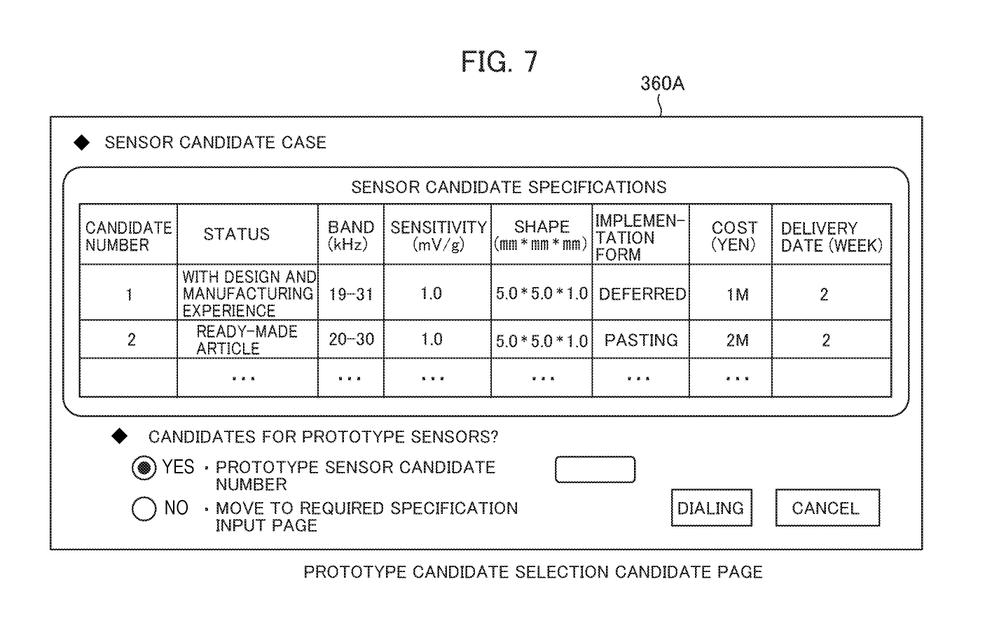

The customer consultation contents are transferred from the customer terminal 12 to the device introduction terminal 13 through the prototype receiving server 10. An operator or a document decoding program searches for a candidate case according to the contents of consultation in an old case, and a prototype candidate selection page 360A to be described later with reference to FIG. 7 is displayed by the customer terminal 12.

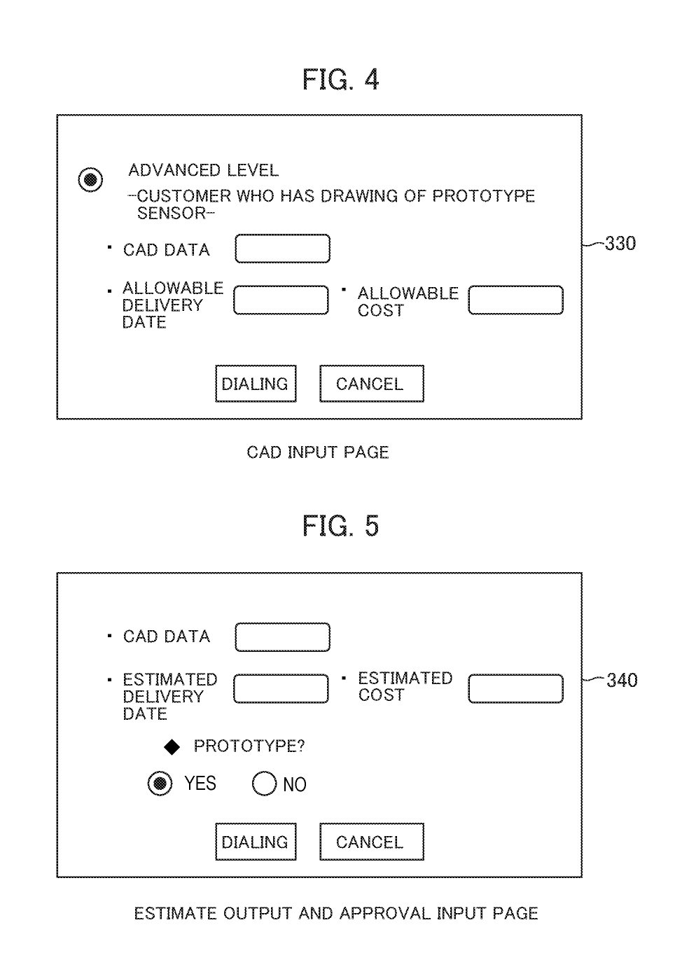

When the advanced level is selected in the request level input page 310, the customer terminal 12 displays a CAD input page 330 exemplified in FIG. 4. The CAD input page 330 causes the customer to enter CAD data, an allowable delivery date (allowable required period), and an allowable cost (budget). When necessary information and CAD data are entered by the customer, the customer terminal 12 displays an estimate output and approval input page 340 exemplified in FIG. 5. The estimate output and approval input page 340 displays an estimation result and prompts approval of manufacturing of the prototype.

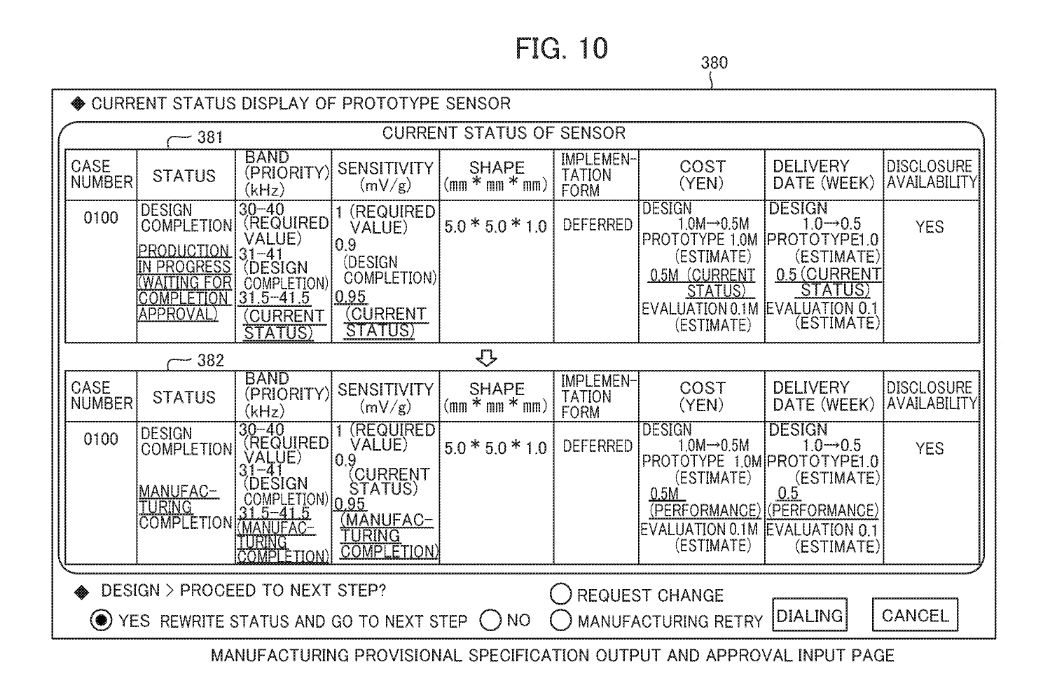

When a production start of the prototype is instructed on the estimate output and approval input page 340, the prototype flow proceeds to a manufacturing process. The customer terminal 12 displays a progress page. The progress page provides, for example, information on a case number, a status, a cost, and a delivery date in a manufacturing provisional specification output and approval input page 380 exemplified in FIG. 10. The progress page may accept an instruction to stop the manufacture of the prototype and an approval input to proceed to an evaluation process. The progress page may display information on the progress of the cost or the delivery date, for example, an initial estimated cost and delivery date and actual values (a current required time or a current cost to be described later) together, and display the respective proportions.

In other words, when a process progresses to some extent at each stage of design and manufacturing, a change occurs from the initial required specification (performance and shape). Also, even during a stage where the required specification has not yet been reached, if there is information from which it is found that the cost and the delivery data which have initially been presented can be reduced, the information is useful for the user's determination (approval). From the above fact, the repeated input and output processing and internal processing can be avoided, and a load on the system can be reduced.

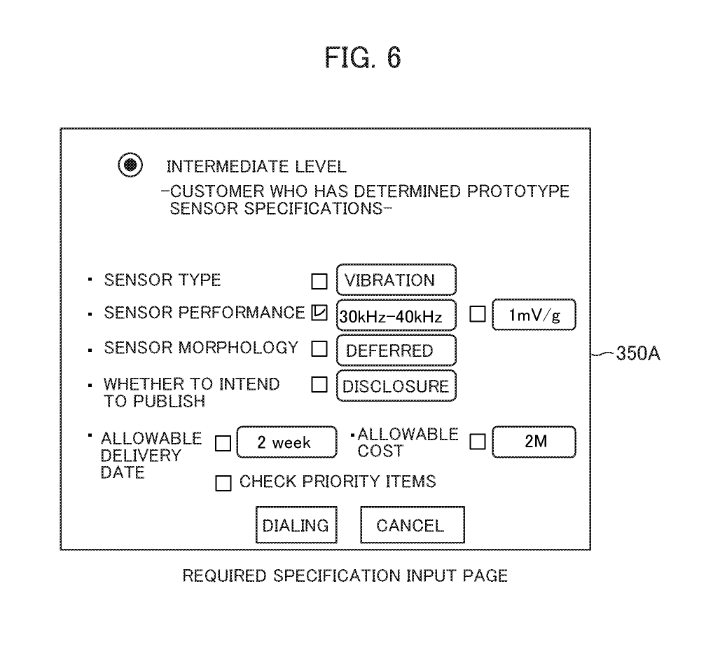

When the intermediate level is selected in the request level input page 310, the prototype flow proceeds to the design process. The customer terminal 12 displays a required specification input page 350A exemplified in FIG. 6, The requires specification input page 350A prompts the customer to enter the type of the sensor, the performance of the sensor, the implementation form, the allowable delivery date and the allowable cost (budget). The required specification input page 350A furthermore prompts the customer to select the priority item and the presence or absence of the disclosure of the prototype information.

The priority items indicate items (for example, bands) to be prioritized in the sensor specification. When the disclosure of the prototype information is permitted, if a new design is made, the design data can be used in future prototyping, and the design of future prototype can be made more efficient. When the customer is allowed to select the permission or rejection of the disclosure, confidentiality of the customer information to be protected can be ensured. When the information disclosure is permitted, for example, a predetermined reduction is made in the prototype cost. This makes it possible to promote the disclosure of the customer's information and to effectively increase the available old case.

When all of the information is input in the required, specification input page 350A, the customer terminal 12 displays a prototype candidate selection page 360A exemplified in FIG. 7. The prototype candidate selection page 360A indicates information on a case (similar case) close to this request which is selected from the old cases or the ready-made products. For example, the prototype candidate selection page 360A displays the cases in descending order of similarity degree. The customer can select one candidate from the prototype candidates being displayed. In this example, the similar case is searched based on the priority item.

In this example, the prototype candidate selection page 360A illustrates a candidate number, a status, a band, a sensitivity, a shape, an implementation form, a cost, and a delivery date (required period). The status distinguishes the ready-made products from the old cases, and indicates a final status in the prototype flow of the old cases. For example, there are a case in which the prototype has been designed but not manufactured, and a case in which the prototype: has been designed and manufactured, A status change of the prototype flow will be described later.

The bandwidth, the sensitivity, the shape and the installation form indicate the values of the respective items in the sensor specification. The cost and delivery date indicate the cost and delivery date required for the prototype of each candidate, respectively. The cost and delivery period of the old case indicate an actual value or an estimated value of the old case depending on the status. The information on the old case and the ready-made product is registered in advance as will be described later.

The provisional design can be presented to the customer efficiently and promptly by presenting the prototype candidate that is similar to the customer request from the old case or the ready-made product items. Constraint conditions including the sensor specification as well as the cost and the delivery date are presented to the customer, thereby making the customer's selection easy.

When one candidate (entry) is selected in the prototype candidate selection page 360A, the subsequent steps are determined according to a status of the candidate. In the case where the ready-made product is selected, the prototype receiving server 10 instructs an external procurement system (not shown) to procure the selected ready-made product, and completes the present prototype flow. When the old case is selected, the prototype flow proceeds to a manufacturing process by the design of the old case. The manufacturing process will be described later.

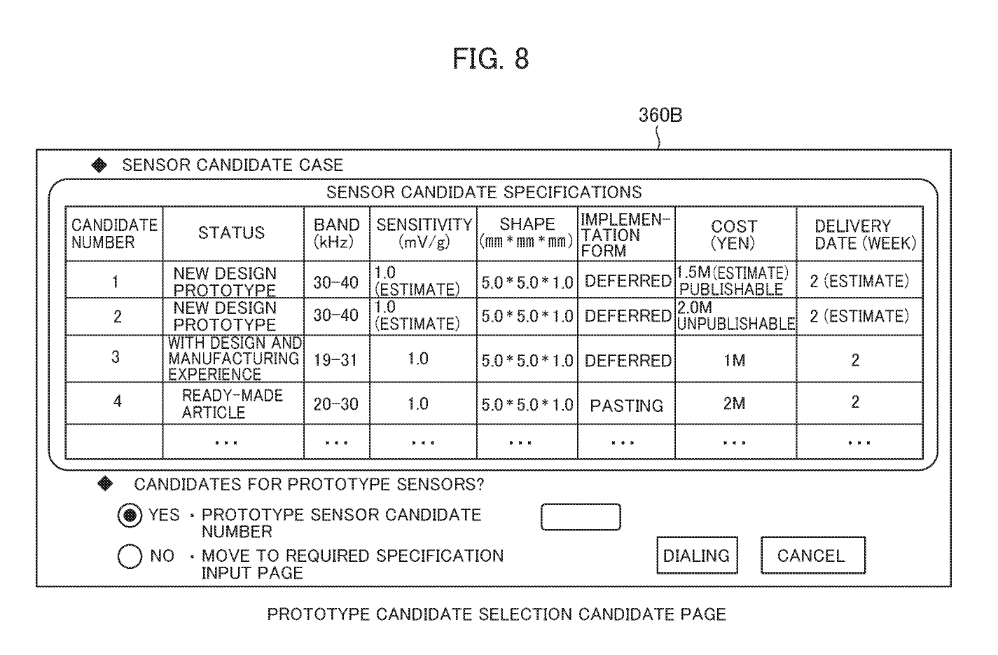

When there is no desired case on the prototype candidate selection page 360A, the customer enters a request for a new design prototype and adds a new case. The new case is a case of the required specification entered in the required specification input page 350A. As illustrated in FIG. 8, the customer terminal 12 displays a prototype candidate selection page 360B to which a new case is added.

The prototype candidate selection page 360B illustrates a new case of the required specification in addition to the case of the prototype candidate selection page 360A. In other words, the prototype candidate selection page 360B indicates a new case of the required specification and a similar case of the new case. The record of the new case is displayed at a top. The value of the item not input to the customer in the new case is, for example, an estimated, value from a similar case. For example, data of a case with the highest degree of similarity of the priority item is used. In the calculation of the cost, when the information disclosure is permitted, the amount (0.5 M yen in FIG. 8) calculated from, an estimated value according to a predetermined method is reduced.

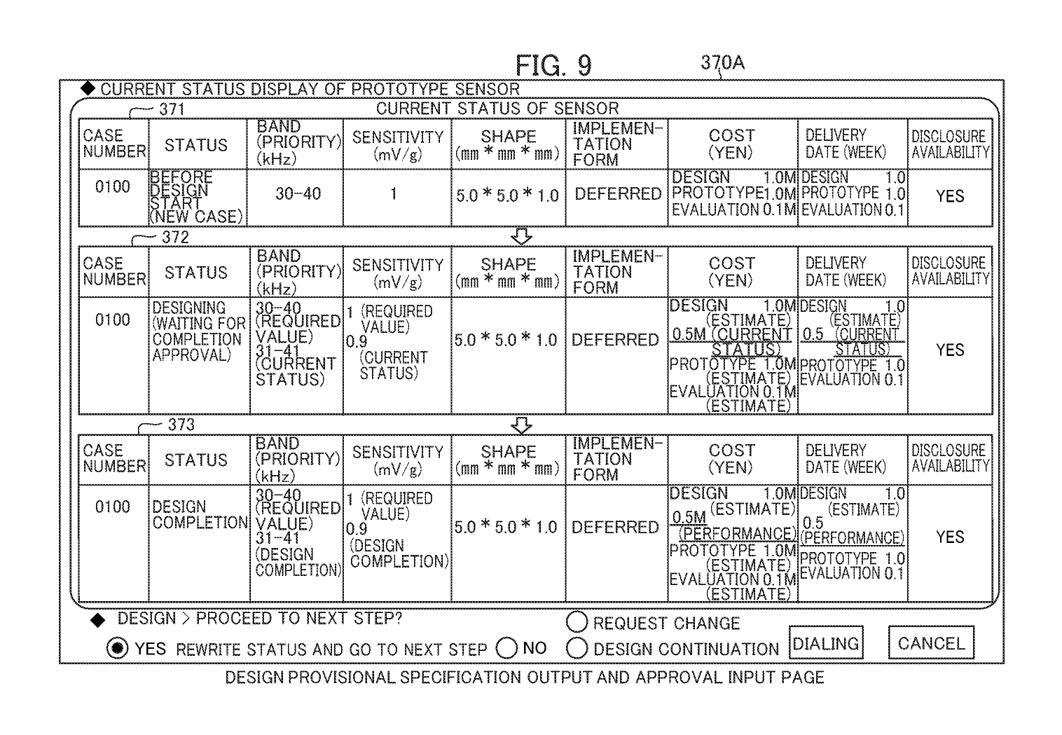

When a new candidate different from, both of the old case and the ready-made product, is selected on the prototype candidate selection page 360B, the selected candidate indicates an initial provisional specification of the prototype. After the initial provisional specification has been determined and the design request from the customer has been received, the customer terminal 12 displays a design provisional specification output, and approval input page 370. FIG. 9 schematically illustrates the design provisional specification output and approval input page 370.

In FIG. 9, the design provisional specification output and approval input page 370 simultaneously displays three records 371, 372 and 373. However, actually, records of different statuses are sequentially displayed. In this manner, the design provisional specification output and approval input page 370 displays the progress of the sensor design in real time for each status.

The design provisional specification output and approval input page 370 indicates information on the provisional specifications as well as the cost and delivery date in each status. More specifically, the design provisional specification output and approval input page 370 indicates the case number, the status, the band, the sensitivity, the shape, the implementation form, the progress information on the cost and the delivery date (the required period), and the permission or prohibition of the disclosure. The case number indicates a case number under design. The status indicates a state in the designing-process. FIG. 9 illustrates a state of before the design start (new case), a state of during designing (before the customer's approval of the completed design), and a state of the design completion after obtaining the customer's approval by the customer of the completed design.

The design provisional specification output and approval input page 370 displays a record 371 before starting the design. The record. 371 indicates information on the new case selected in the prototype candidate selection page 360. The cost and the delivery date indicate the respective progress information, and more specifically, indicate estimated values in each step of design, manufacturing, and evaluation.

In the design provisional specification output and approval input page 370, when the customer approves the record 371 and permits the process to proceed to the next step (the actual design of the prototype), the prototype receiving server 10 rewrites the record in the design provisional specification output and approval input page 370. The customer terminal 12 displays the rewritten design provisional specification output and approval input page 370.

For example, in the rewritten record (not shown), items other than the status, the cost, and the delivery date indicate values similar to those of the record 371. The status indicates, for example, “under designing”, the cost and the delivery date indicate the same values as those of a record 372. The design cost and delivery date are shown with the initial estimated, value in each process and the value (current value) required for the current provisional specification in the design. As a result, the customer can compare the current value with the estimated value before the start of design.

As will be described later, the prototype receiving server 10 calculates an actual cost and an actual required time of one trial in the design by a predetermined method, and adds the calculated actual cost and actual required time to the current cost and the current delivery date in the design to update the current cost and the delivery date. FIG. 9 shows an example in which the cost and the delivery date have already increased by 0.5 each time in five trials. The present value before the first trial is 0. The initial estimated value is determined assuming, for example, 10 trials, and the present record may not be displayed.

Upon completion of the design trial, the prototype receiving server 10 rewrites the record in the design provisional specification output and approval input page 370. The customer terminal 12 displays a “designing (waiting for competition approval)” record 372. The record 372 indicates the initial estimated value in the required specification and the current value (current estimated value) of the provisional specification obtained by the current design together in the sensor specification (bandwidth and sensitivity). The design specification and the required specification do not always match each other based on the design method of the sensor.

In the design provisional specification output and approval input page 370, when the customer approves the record 372 and then allows the process to proceed to the next step, the prototype receiving server 10 rewrites the record in the design provisional specification output and approval input page 370 to a design completion record 373. The customer terminal 12 displays the rewritten design provisional specification output and approval input page 370.

In the design provisional specification output and approval input page 370, if the customer recognizes that the sensor specification of the record 372 is insufficient and does not approve the sensor specification, the continuation of the design trial is selected by the customer. The prototype receiving server 10 executes (requests) a new trial of the prototype design according to the selection (selection of retrial) of the design continuation. With the repetition of the design, the provisional specification can be brought closer to the required specification.

When repeating the design trial, the prototype receiving server 10 rewrites the record to the “designing” record by the data received from the prototype receiving server 10 on the design provisional specification output and approval input page 370, Because of the design of a second trial, the present values of the cost and the delivery date further increase. The increase value is the same as that in the previous trial.

As described above, the information on the provisional specification as well as the cost estimation and delivery estimation for each status in the design process is presented to the customer, and feedback from the customer is reflected in the design. As a result, in the constraint conditions (cost and delivery date) that match the customer's request, the sensor or the sensor specification that matches the customer's request can be efficiently designed.

The prototype receiving server 10 displays the specification of the result of the design trial received from the design department system 14 or the estimated specification of the result of the design trial calculated by the own device on the design provisional specification output and approval input page 370.

For example, as will be described later, the prototype receiving server 10 transmits a request for design trial to the design department system 14 to receive information on the specification of the design trial result. The prototype receiving server 10 repeats the request for the design trial to the design department system 14 and the display of the specification of the design trial result until the approval is input from the customer.

In addition, the prototype: receiving server 10 may estimate the specification of the result of the design trial and display the estimated specification on the approval input page 370 before transmitting the request for the design trial to the design department system 14, The specification calculated by the design department system 14 is more accurate, but a calculation step by the design department system 14 can be shortened with the use of the estimation by the calculation in the prototype receiving server 10. As described above, when a faster reception is desired, the specification can be calculated by the design department system 14.

In that case, the prototype receiving server 10 snares information indicating a relationship between the number of design trials and a deviation from the required specification with the design department. For example, the prototype receiving server 10 holds a ratio of a deviation between the specifications of a predetermined number of trial results and the required specification. For example, the information indicates that the deviations between the respective specifications of one trial, five trials, and ten trials and the required specification fall within 5%, within 1%, within 10%.

The prototype receiving server 10 calculates an estimated specification according to the number of trials with the use of the above information, and displays the calculated estimated specification on the approval input page 370. Upon receiving an input of the approval for the calculated specification in a specific number of trials, the prototype receiving server 10 transmits a request for design to the design department system 14 together with the information on the approved specification. The design department system 14 repeats the design trial until the specification is satisfied. The prototype receiving server 10 may transmit the request for the design trial to the design department system 14 instead of the calculation of the specification, and display the specification of the design result on the design provisional specification output and approval input page 370.

In the case where there is a change in the priority item or a change in the sensor specification from the customer, the customer terminal 12 displays the required specification input page 350A shown in FIG. 6 according to a request change instruction from the customer. The subsequent calculation of the cost and the delivery date starts from an updated current value.

The customer terminal 12 may accept a stop instruction from the customer at an arbitrary time. For example, before the approval after the design has been completed, and from the design start to the design end, the customer terminal 12 may accept a stop instruction from the customer. The input cancel instruction is transmitted to the prototype receiving server 10. The prototype receiving server 10 stops the design in progress.

Upon receiving the request from the customer, the customer terminal 12 acquires and displays the design provisional specification output and approval input page 370 from the prototype receiving server 10. When the design status changes, the prototype receiving server 10 may notify the customer terminal 12 of the fact that the design status changes.

The state in the design may be defined in more detail. One or more states are defined between design start and the design end, and the estimates of the provisional sensor specification, costs and delivery date are calculated and displayed for each state. The cost and time caused for unnecessary design can be reduced by accepting the stop instruction from the customer even during designing.

When the approval from the customer for a “designing” record 372 (or “design completion” record 373) (waiting for completion approval) is obtained, the prototype flow proceeds to a next manufacturing process. When the customer does not approve the sensor specification of the record 372, the prototype flow may be terminated without transitioning to the manufacturing process in response to an additional instruction from the customer.

After the design is determined in the design provisional specification output and approval input page 370 and a request for manufacturing is received from the customer, the customer terminal 12 displays a manufacturing provisional specification output and approval input page 380. FIG. 10 schematically illustrates the manufacturing provisional specification output and the approval input page 380.

In FIG. 10, the manufacturing provisional specification output and approval input page 380 simultaneously displays two records 381 and 382, but in fact, records of different status are sequentially displayed. In this way, the manufacturing provisional specification output and approval input page 380 displays the progress of the manufacture of the sensor prototype in real time for each status.

The manufacturing provisional specification output and approval input page 380 indicates information on the provisional specification as well as the cost and delivery date in each status. More specifically, the manufacturing provisional specification output and approval input page 380 indicate a case number, a status, a band, a sensitivity, a shape, an implementation form, the progress information on the cost and the delivery, and the permission or prohibition of the disclosure. The status indicates a state in the manufacturing process. In FIG. 10, the states of under prototyping (waiting for completion of approval) and completion of prototyping are exemplified. The cost and delivery date indicate progress information.

The manufacturing provisional specification output and approval input page 380 may display a “manufacturing” record (not shown) before the prototyping (waiting for completion of approval) record 381. The manufacturing record indicates the same values as the items other than the status, the band, and the sensitivity, for example, in the record under manufacturing (waiting for completion of approval) 381. The status indicates “under manufacturing”, and the band and the sensitivity indicate values other than the current value by manufacturing.

The manufacturing provisional specification output and approval input page 380 displays the manufacturing (waiting for completion of approval) record 381 after completion of manufacturing (before approval). The record 381 records a required value, a design value, and a current value on manufacturing in the band and sensitivity. The current value on the manufacturing is obtained by simulating the performance based on the actually machined device shape, and the specification by design and the required specification do not necessarily completely match each other.

The manufacturing (waiting for the completion approval) record 381 indicates the progress information in the cost and the delivery date, and specifically indicates an estimated value and a design completion time estimated value in the required specification of each process, and a current value in manufacturing. As a result, the customer can compare the current value in the manufacturing process with the design value and the required value. In addition, the customer can compare the current value with the initial estimated value in the budget and cost.

The prototype receiving server 10 calculates the cost and the period of one trial in manufacturing by a predetermined method, adds the calculated cost and delivery date to the current cost and delivery date in manufacturing, and updates the current cost and the delivery date. In an example of FIG. 10, in one trial, the cost and the delivery date increase by 0.5. The current value before the first trial is 0.

In the manufacturing provisional specification output and approval input page 380, when the customer approves the manufacturing (waiting for completion of approval) record 381 and permits the process to proceed to the next step (manufacturing completion), the prototype receiving server 10 rewrites the manufacturing provisional specification output and the record in the approval input page 380 to the manufacturing completion record 382. The customer terminal 12 displays the rewritten manufacturing provisional specification output and the approval input page 380.

In the manufacturing provisional specification output and approval input page 380, when the customer recognizes that the sensor specification of the manufacturing (waiting for the completion approval) record 381 is insufficient and does not approve the sensor specification, retrial of prototype manufacturing is selected by the customer. The prototype receiving server 10 executes (requests) a new prototype of prototype manufacturing according to the selection of manufacturing retrial. The provisional specification can be brought close to the required specification by repeating manufacturing.

In the case of repeating manufacturing, the prototype receiving server 10 rewrites the record to the “manufacturing” record on the basis of the data received from the prototype receiving server 10 on the manufacturing provisional specification output and approval input page 370, or generates the manufacturing provisional specification output and approval input page 370 indicating “under manufacturing”. Because of the second trial design, the current values of the budget and the delivery date further increases from the previous values. The incremented value is the same as that of the previous trial.

In this way, the information on the provisional specification as well as the cost estimation and the delivery estimation for each status in the manufacturing process is presented to the customer and the feedback from the customer is reflected in manufacturing. As a result, in the constraint conditions (the cost and the delivery date) that match the customer's request, the sensor with the sensor specification that match the customer's request can be efficiently manufactured.

Upon receiving a request from the customer, the customer terminal 12 acquires and displays the manufacturing provisional specification output and the approval input page 380 from the prototype receiving server 10. When the manufacturing status is changed, the prototype receiving server 10 may notify the customer terminal of the change in the manufacturing status.

In the case where there is a change in the priority item or a change in the sensor specification from the customer, the prototype receiving server 10 creates the required specification input page 350A shown in FIG. 6 in response to a request change instruction from the customer, and displays the created required specification input page 350A on the customer terminal 12. The subsequent calculation of the cost and the delivery date starts from the updated current values.

The customer terminal 12 may accept a stop instruction from the customer at an arbitrary time. For example, before the approval after the design has been completed and from, the design start to the design end, the customer terminal 12 may accept the stop instruction from the customer. The input cancel instruction is transmitted to the prototype receiving server 10. The prototype receiving server 10 stops the manufacturing in progress.

The state in manufacturing may be defined in more detail. From a manufacturing start to a manufacturing end, one or more states are defined, and the provisional sensor specification, budget and delivery date are calculated and displayed for each state. The cost of unnecessary manufacturing can be reduced by accepting the stop instruction from customers even during manufacturing.

The customer terminal 12 displays the evaluation result of the prototype after the prototype manufactured on the manufacturing provisional specification output and approval input page 380 is approved by the customer and the evaluation request is received from the customer. The prototype receiving server 10 generates an evaluation result output page 390 indicating the evaluation result, and the customer terminal 12 displays the evaluation result output page 390.

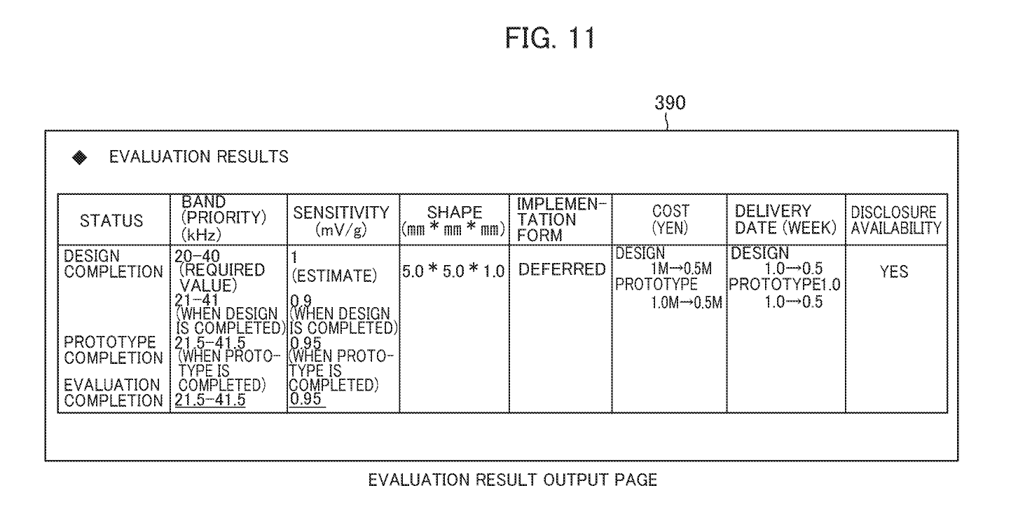

FIG. 11 shows an example of the evaluation result output page 390. The evaluation result output page 390 includes an evaluation result record and shows a status, a band, a sensitivity, a shape, an implementation form, a cost, a delivery date, and the permission or prohibition of the disclosure. The evaluation result output page 390 indicates that all steps of the status, the design, the manufacturing, and the evaluation have been completed. The band and the sensitivity indicate the customer's required value, the design completion time estimated value, the manufacturing completion time estimated value, and the evaluated value. The cost and delivery date indicate the initial estimated value and the determined value in the design and manufacturing. The evaluation result output page 390 allows the customer to confirm, the information and the final evaluation result in each step of the prototype flow.

As described above, in the prototype service system according to the present, embodiment, the design, manufacture, and evaluation cooperate with each other closely, and the prototype service system presents the provisional sensor specification, the cost and the delivery estimation, and the evaluation result in a different process in the prototype flow to the customer and receives feedback from the customer. As a result, the sensor device that matches the changeable customer's request, can be efficiently and promptly prototyped.

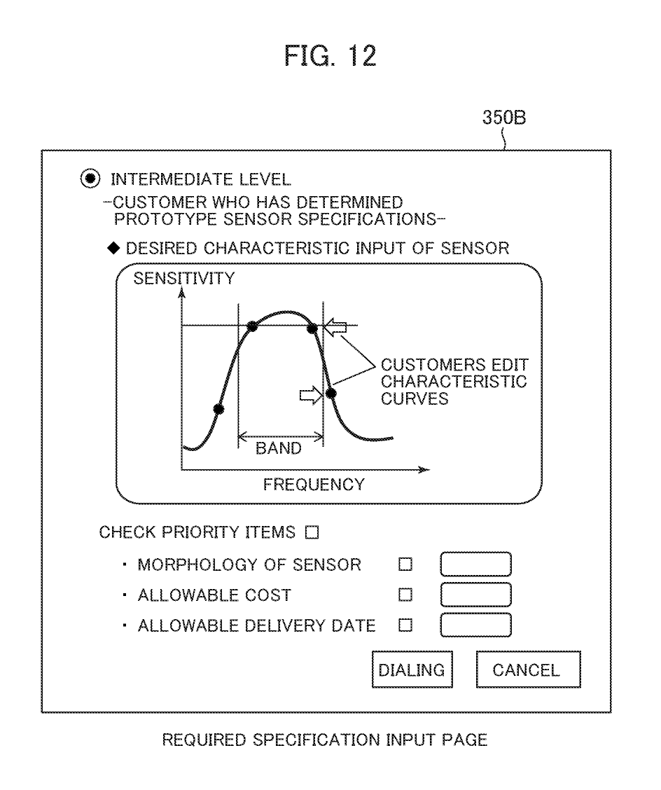

FIG. 12 shows another example 350B of the required specification input page. The customer can enter the required sensor specification with the use of a graph in the required specification input page 350B. In an example of FIG. 12, the required specification input page 350B displays an editable sensor characteristic curve (indicating a relationship between the band and the sensitivity). The customer uses the input and output device 126 to change positions of multiple points in the graph.

For example, the prototype receiving server 10 includes a function indicating a sensor characteristic curve including coordinates of a movable point as an argument in the data of the required specification input page 350B. According to the GUI program 128, the customer terminal 12 displays the sensor characteristic curve according to the function and the coordinates of the movable point. When the coordinates of the movable point are changed by the customer (for example, using the mouse), the GUI program 128 recalculates and redisplays the sensor characteristic curve according to a change in the coordinates.

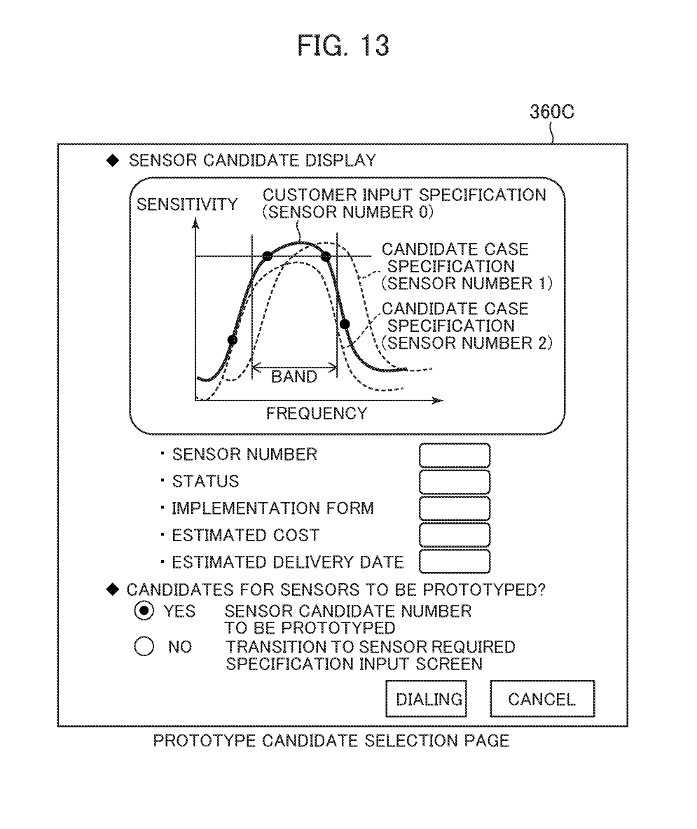

FIG. 13 shows another example 360B of the prototype candidate selection page. The prototype candidate selection page 360B displays the required specification and the sensor specification of the candidate case similar to the required specification with the use of a graph. In the example of FIG. 13, the prototype candidate selection page 360B displays a sensor characteristic curve (indicating a relationship between the band and the sensitivity). When any one of the curves is selected, the customer terminal 12 displays information on the estimated cost and estimated delivery date of the curve.

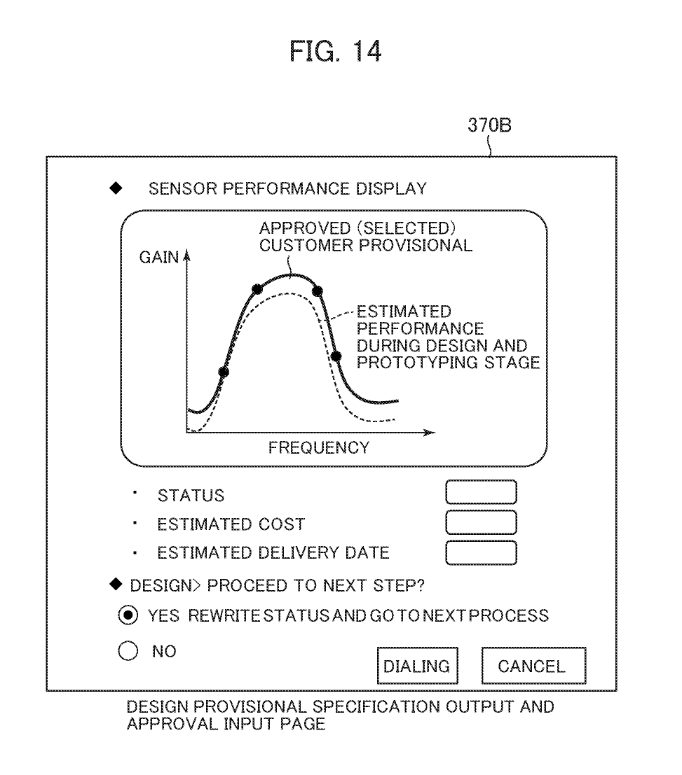

FIG. 14 shows another example 370B of the design provisional specification output and approval input page. The design provisional specification output and approval input page 370B displays the required sensor specification and the sensor specification of the candidate case with the use of a graph. In the example of FIG. 14, the design provisional specification output and approval input page 370B displays a sensor characteristic curve (showing a relationship between the band and the sensitivity). As shown in FIGS. 12 to 14, the elastomer can more intuitively recognize the sensor specification by the graph.

Hereinafter, a software configuration example of the prototype receiving server 10 will be described. FIG. 15A shows a configuration example of the reception control program 108 stored in the prototype receiving server 10. The reception control program 108 includes multiple program modules (programs). More specifically, the reception control program 108 includes a design prototype receiving unit 181, a beginner level receiving unit 182, a required specification receiving unit (intermediate level) 183, an advanced level receiving unit 184, a design interface unit 185, a manufacturing interface unit 186, and an evaluation interface unit 187.

The reception control program 108 further includes a priority item extraction unit 188, an old case search unit 189, a ready-made case search unit 190, a candidate specification generation unit 191, a candidate specification display unit 192, and a provisional specification generation unit 193. As described above, the CPU 103 operates as respective functional units according to the program module.

FIG. 15B shows an example of a database stored in the prototype receiving server 10. The auxiliary memory 105 of the prototype receiving server 10 stores an old case specification database (DB) 501, the ready-made product specification database 502, and the customer specification database. The customer specification database includes a required specification database 511, a candidate specification database 512, a provisional specification database 513, and a result specification database 514.

The old case specification database 501 and the ready-made product specification database 502 are prepared in advance before the prototype flow is started, which is a database common to the customers. The customer specification database is a database generated in the prototype flow for each customer.

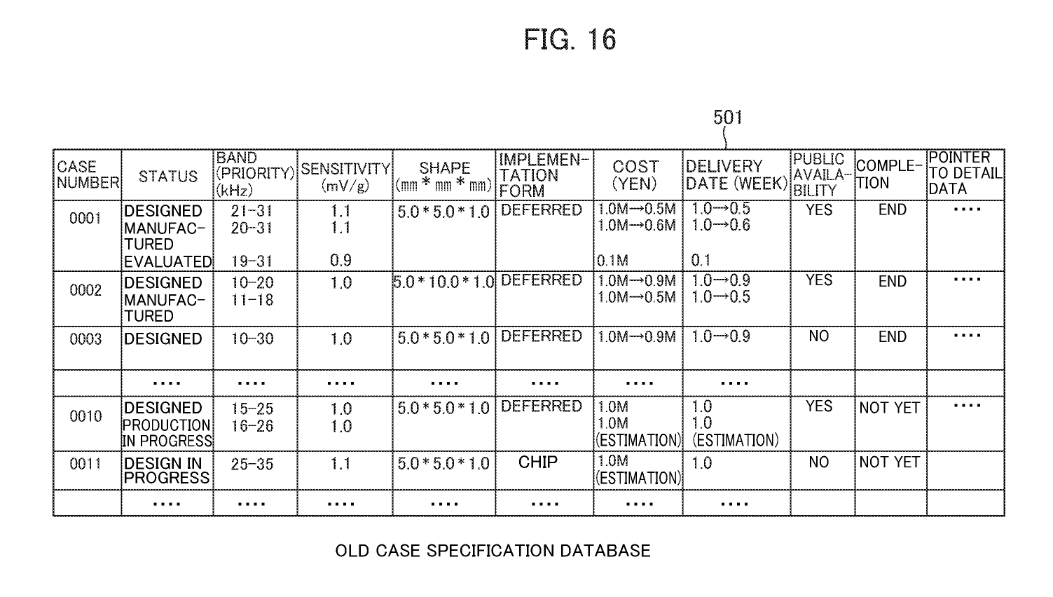

FIG. 16 shows an example of the configuration of the old case specification database 501, The old case specification database 501 stores related information of sensors (cases) designed in the past, including sensor specifications. The old case specification database 501 includes information on cases in which the prototype flow has been completed as well as cases in which the prototype flow continues. As a result, the number of cases similar to customer's required specification is increased.

The old case specification database 501 indicates the status, the band, the sensitivity, the shape, the implementation form, the cost, the required time (delivery date), the permission or prohibition of the disclosure, the presence or absence (“completion”) of the prototype flow completion, and a point to detailed data in each case. The status indicates the state in each step of design, manufacture, and evaluation. The sensor specification (band, sensitivity, shape, implementation form) shows the estimated value and the evaluation value in each process. The values of the executed process are shown.

The cost and the required time indicate estimated, values and actual values (determined values) in each process. The “completion” column indicates the completion (“completion”) or incomplete (“not yet”) of the prototype flow in each case. The pointer to the detailed data indicates a pointer to the detailed process chart of the case.

For example, a case with a case number “0001” is a case where the prototype flow has been completed, and the record shows the evaluation value in addition to the actual value in the design and manufacture of the band and the sensitivity. The shape and the implementation form are common to all steps. The record shows the estimated value and the actual value in design and manufacturing and the actual value of evaluation in the cost, and the required time. The old case specification database 501 can effectively leverage the information on the old case based on the prototype flow.

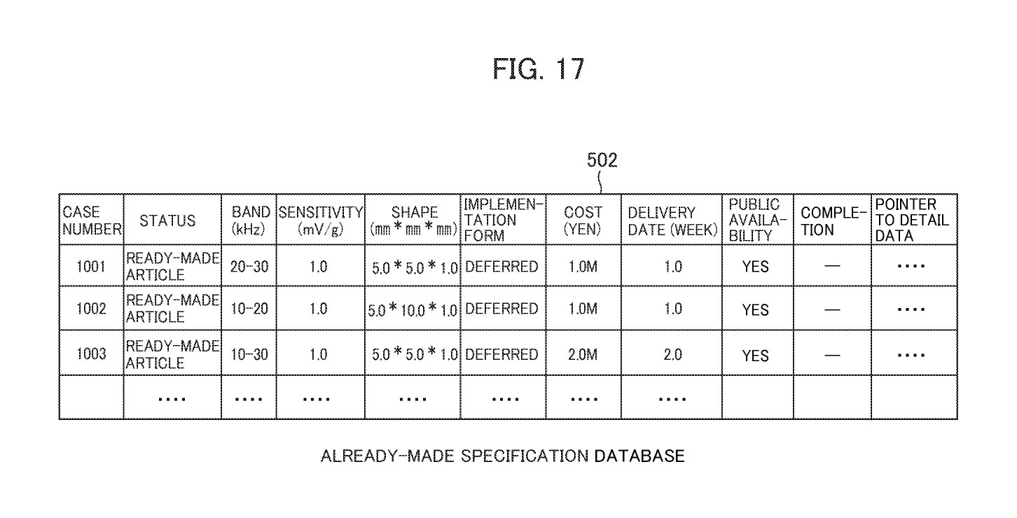

FIG. 17 shows an example of the configuration of the ready-made product specification database 502. The ready-made product specification database 502 stores related information of the ready-made sensor (case) including the sensor specification. The type of the information stored in the ready-made product specification database 502 is the same as that in the old case specification database 501. The status of all the cases is ready-made products. The ready-made product specification database 502 may be omitted.

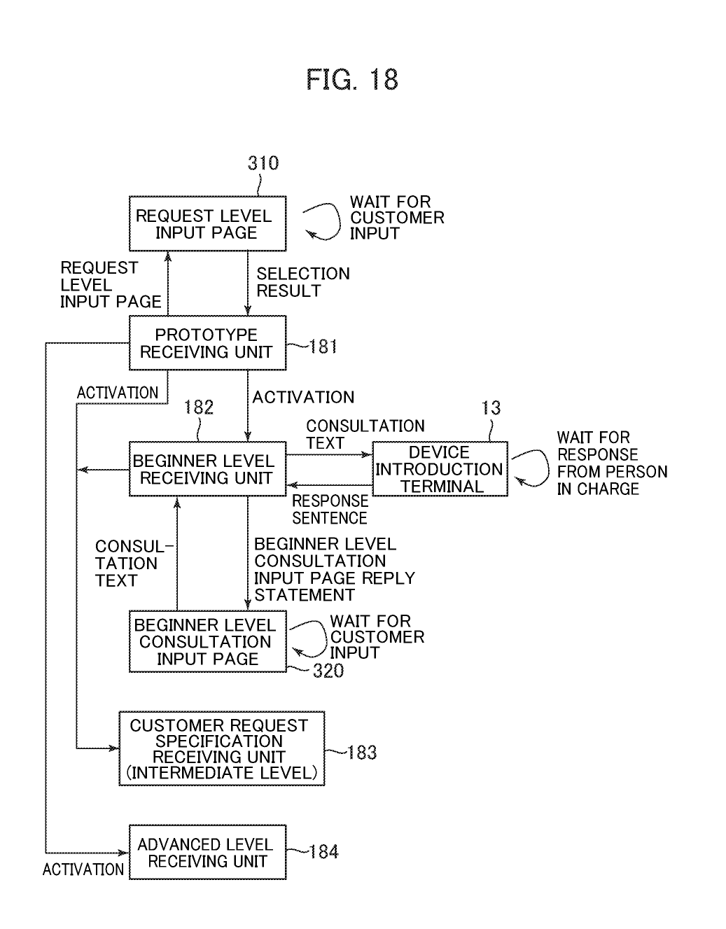

Hereinafter, processing of the prototype service system for providing the prototype service by the GUI for the customer will be described. FIG. 18 shows a data flowchart in the user interface in the determination of a request level (customer level) and the beginner level.

Upon activation, the design prototype receiving unit 181 generates a unique case number. The design prototype receiving unit 181 generates a request level input page 310 in response to a request from the customer terminal 12 and transmits the generated request level input page 310 to the customer terminal 12. The design prototype receiving unit 181 waits for a response from the customer terminal 12.

The customer selects the request level in the request level input page 310, and the design prototype receiving unit 181 receives the selection result from the customer terminal 12. The design prototype receiving unit 181 activates the beginner level receiving unit 182, the required specification receiving unit (intermediate level) 183, or the advanced level receiving unit 184 according to the selected request level.

Upon activation, the beginner level receiving unit 182 generates a beginner level consultation input page 320 and transmits the generated beginner level consultation input page 320 to the customer terminal 12. The beginner level receiving unit 182 waits for a response from the customer terminal 12. The beginner level receiving unit 182 receives from the customer terminal 12 a consultation text entered by the customer on the beginner level consultation input page 320. The beginner level receiving unit 182 transmits the consultation text to the device introduction terminal 13. The device introduction terminal 13 returns a response sentence for the consultation created by a person in charge to the prototype receiving server 10.

The beginner level receiving unit 182 generates a beginner level consultation input page 320 including the response sentence and transmits the generated beginner level consultation input page 320 to the customer terminal 12. The response sentence includes, for example, a recommended sensor specification or a description promoting proceeding to the required specification input page 350A. The beginner level receiving unit 182 may activate the required specification receiving unit 183 and transmit information on the sensor specification (input information to the required specification input page 350A) included in the response sentence.

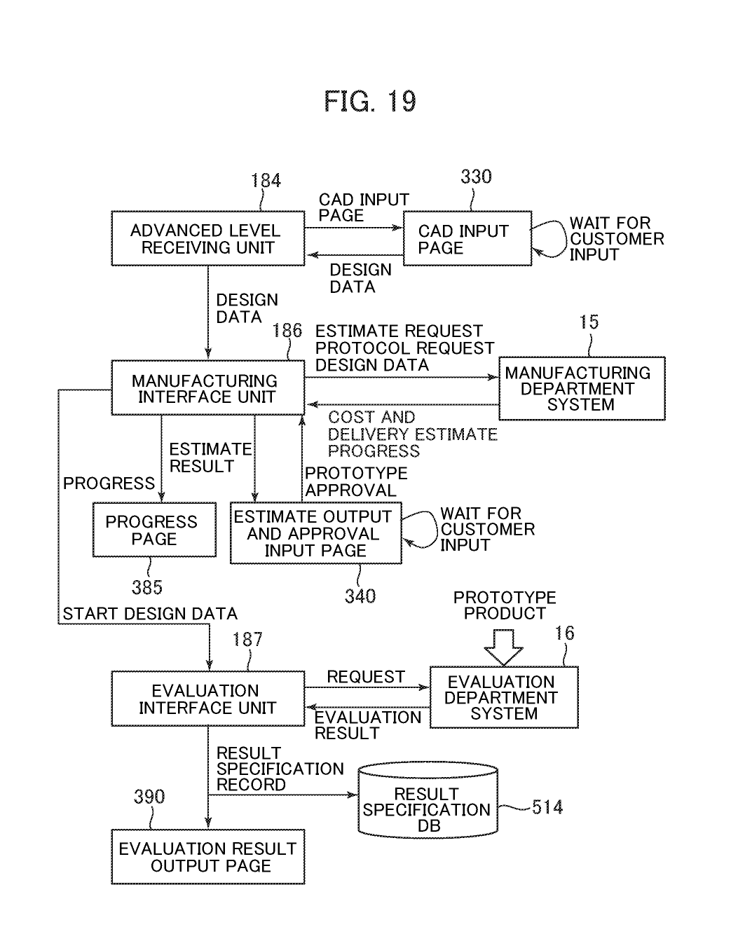

FIG. 19 shows a data flowchart of a prototype flow at the advanced level. Upon activation, the advanced level receiving unit 184 generates a CAD input page 330 and transmits the CAD input page 330 to the customer terminal 12. The advanced level receiving unit 184 waits for a response from the customer terminal 12. The advanced level receiving unit 184 receives the design data (CAD data) input to the customer through the CAD input page 330 from the customer terminal 12. Upon receiving the design data, the advanced level receiving unit 184 activates the manufacturing interface unit 186.

The manufacturing interface unit 186 receives the design data from the advanced level receiving unit 184. The manufacturing interface unit 186 transmits a cost and delivery date estimation request together with the design data to the manufacturing department system 15, The manufacturing interface unit 186 receives the estimated cost and the estimated delivery date for the requested design data from the manufacturing department system 15.

The manufacturing interface unit 186 generates the estimate output and approval input page 340 including the estimated cost and the estimated delivery date, and transmits the estimate output and approval input page 340 to the customer terminal 12, The manufacturing interface unit 186 waits for a response from the customer terminal 12, The manufacturing interface unit 186 receives the prototype approval for the estimate output and approval input page 340 from the customer terminal 12.

Upon receiving the prototype approval, the manufacturing interface unit 186 transmits the prototype request to the manufacturing department system 15. The manufacturing interface unit 186 receives information on the progress of manufacturing from the manufacturing department system 15. The manufacturing interface unit 186 generates a progress page 385 according to the progress and transmits the progress page 385 to the customer terminal 12. The progress information received by the manufacturing interface unit 186 includes the determined value of the sensor specification of the prototype. The manufacturing interface unit 186 calculates the cost and the delivery date according to a preset method as described above.

After the manufacture has been completed, upon receiving the customer's approval and evaluation request, the manufacturing interface unit 186 activates the evaluation interface unit 187. The evaluation interface unit 187 designates the prototype and transmits the evaluation request to the evaluation department system 16. The evaluation interface unit 187 waits for a response from the evaluation department system 16.

The person in charge of the evaluation department obtains the prototype from the manufacturing department and executes the evaluation. The evaluation interface unit 187 receives the evaluation result from the evaluation department system 16. The evaluation interface unit 187 generates a result specification record including the sensor specification received from the manufacturing department system 15, the calculated cost and delivery date, and the evaluation result, and stores the result specification record in the result specification DB 514, The evaluation interface unit 187 generates an evaluation result output page 390 and transmits the evaluation result output page 390 to the customer terminal.

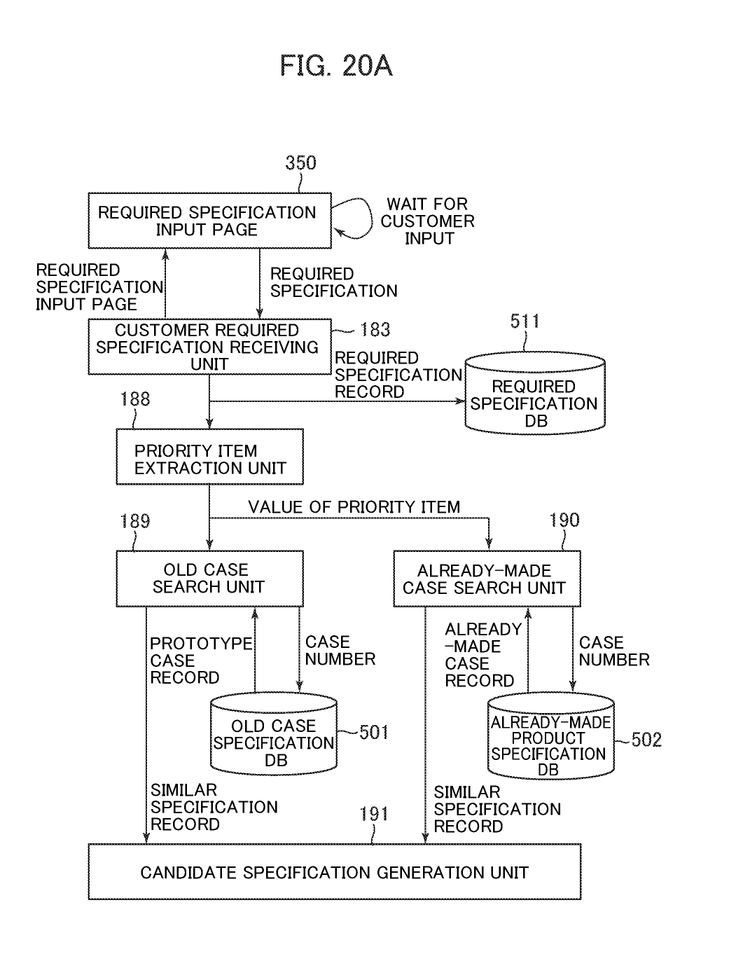

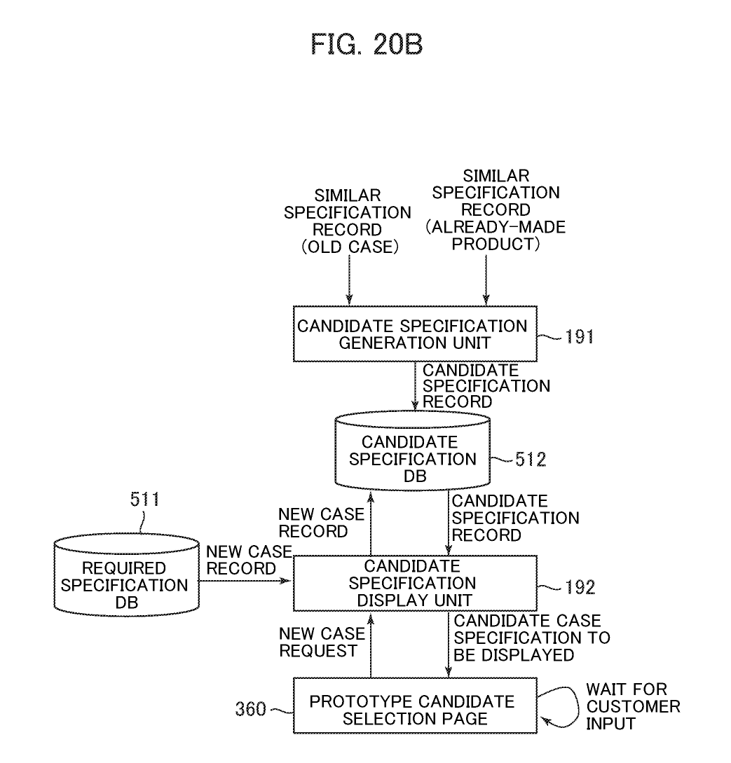

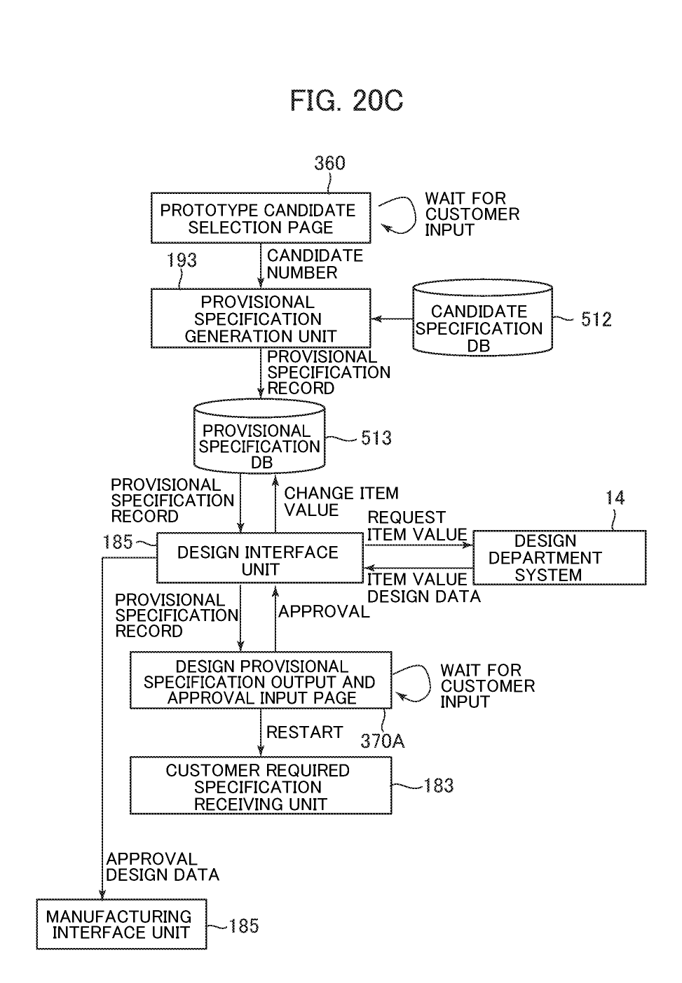

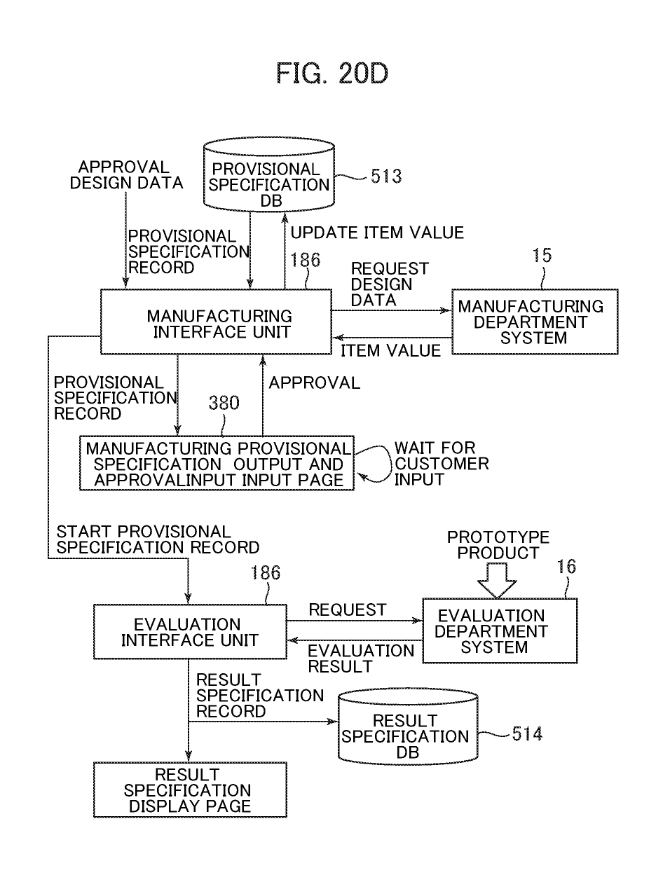

FIGS. 20A to 20D show data flowcharts of a prototype flow at the intermediate level. Each time activation, the required specification receiving unit 183 generates only one case number. As shown in FIG. 20A, the required specification receiving unit 183 generates a required specification input page 350 in response to a request from the customer terminal 12, and transmits the required specification input page 350 to the customer terminal 12. The required specification receiving unit 183 waits for a response from the customer terminal 12.

The required specification receiving unit 183 receives the customer's request from the customer terminal 12. The customer's request includes the customer's required specification (sensor specification), the prototype conditions (cost and delivery date), the priority item, and the designation of presence or absence of the information disclosure.

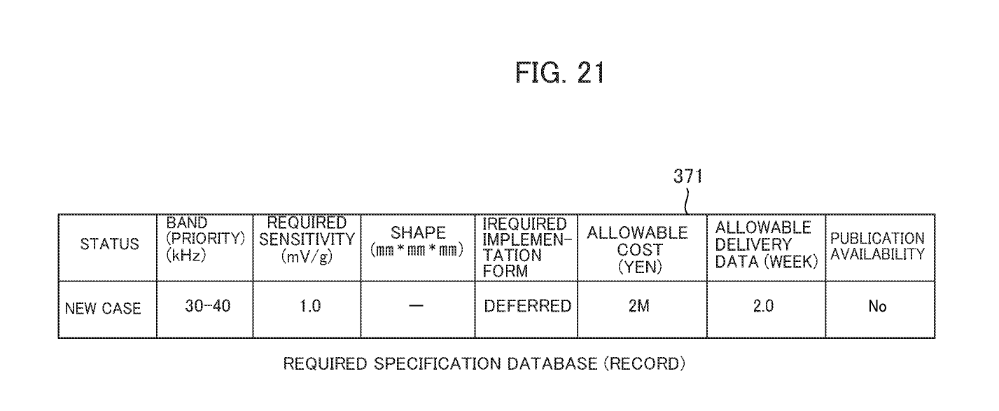

The required specification receiving unit 183 generates a required specification record from the received customer request and stores the required specification record in the required specification database 511. FIG. 21 shows a configuration example of the required specification database 511, The required specification database 511 stores only one required specification record. The required specification record shows the status, the requested band, the requested sensitivity, the shape, the requested implementation form, the allowable cost, the allowable delivery date, and the permission or prohibition of the disclosure.

The required specification record is a new case different from the old case and the ready-made product, and the status indicates the new case. The required sensor specification (required band, required, sensitivity, installation form) and the prototype conditions (allowable cost, allowable delivery date, and the permission or prohibition of the disclosure) indicate values entered by the customer in the required specification input page 350. For example, a NULL value is stored since the shape is not specified in the required specification input page 350. The required specification record further clearly shows the selected item as a priority item. In this example, the band is selected as the priority item.

Returning to FIG. 20A, the priority item extraction unit 188 receives the required specification record from the required specification receiving unit 183, specifies the priority item, and extracts a value of the priority item. The priority item extraction unit 188 transmits the value of the priority item to the old case search unit 189 and the ready-made case search unit 190.

The old case search unit 189 searches for the case similar to the requested specification in the old case specification database 501. Specifically, in the valid cases (entries) of the old case specification database 501, the old case search unit 189 search for the old case where the similarity of the priority item exceeds a prescribed level. The valid items can be open to the public and have the design completed.

As a method of calculating the similarity, an appropriate method is predefined according to the item. For example, the similarity of the band can be calculated according to the following expression.

√(Customer Required Frequency Upper Limit−Case Frequency Upper Limit)̂2+(Customer Required Frequency Lower Limit−Case Frequency Lower Limit)̂2)

The similarity of the sensitivity can be calculated by (customer required sensitivity−case frequency sensitivity).

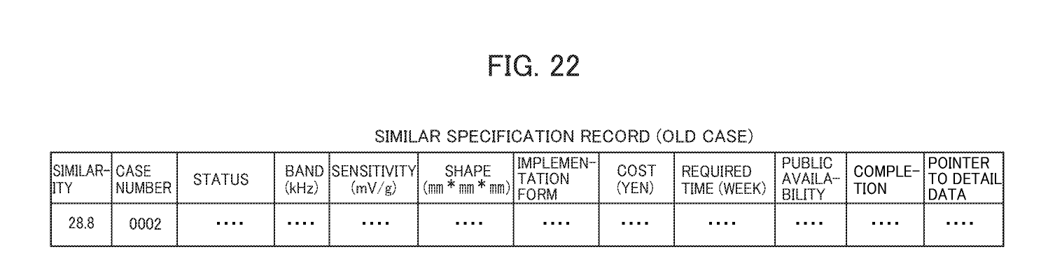

The old case search unit 189 generates a similarity specification record from each of the found similar old case records. FIG. 22 shows a configuration example of the similarity specification record of the old case. The similarity specification record indicates the similarity calculated by the old case search unit 189 in addition to the information on the record of the old case specification database 501. The old case search unit 189 transmits the generated similarity specification record to the candidate specification generation unit 191.

The ready-made case search unit 190 searches for the cases similar to the required specification in the ready-made product specification database 502. Specifically, in the valid cases (entries) of the ready-made product specification database 502, the ready-made case search unit 190, a case where the degree of similarity of the priority item exceeds the prescribed level is searched for. The effective cases are cases which can be open to the public. The similarity calculation method is the same as that in the old case search unit 189.

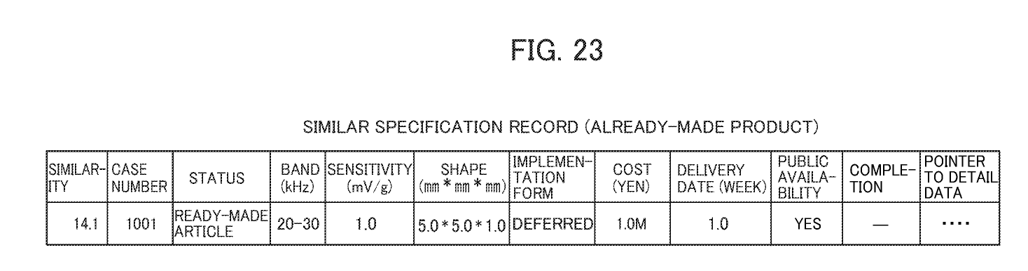

The ready-made case search unit 190 generates the similarity specification records from each of the found similarity ready-made products records. FIG. 23 shows an example of the configuration of the similarity specification record of the ready-made product. The similarity specification record indicates the similarity calculated by the ready-made case search unit 190 in addition to the information on the record of the ready-made specification database 502. The ready-made case search unit 190 transmits the generated similarity specification record to the candidate specification generation unit 191.

In this example, one priority item is designated, but multiple priority items may be designated. For example, the old case search unit 189 and the ready-made case search unit 190 select the cases exceeding the prescribed level as the similar cases in each of the multiple priority items. The search of the similar cases may be executed in parallel in multiple databases in parallel or may be executed sequentially.

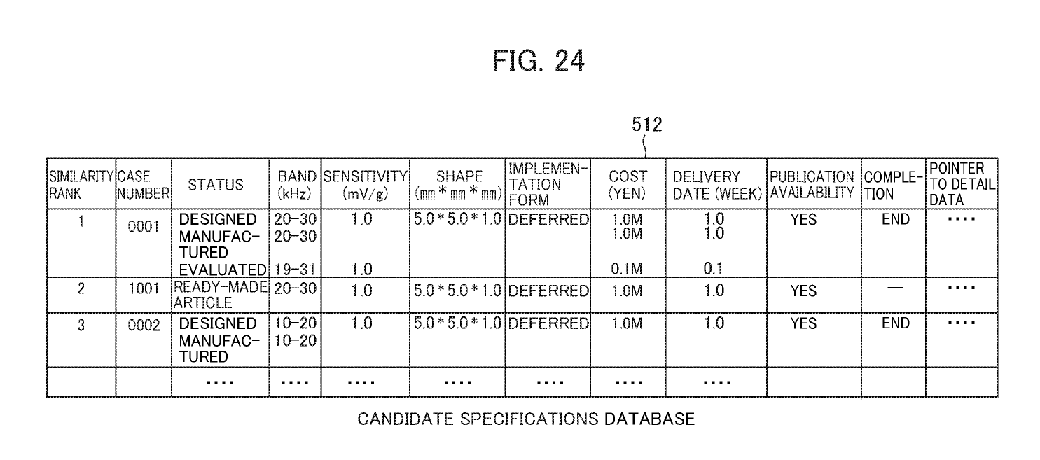

As shown in FIG. 20B, the candidate specification generation unit 191 generates a candidate specification record from each of the received similarity specification records and stores the generated candidate record in the candidate specification database 512. FIG. 24 shows a configuration example of the candidate specification database 512. The candidate specification record is a record of the candidate specification database 512.

The candidate specification record indicates the similarity rank in place of the similarity degree of the similarity specification record of the old cases and the ready-made products. The candidate specification record changes the “required time” of the similarity specification record of the old cases to “delivery date”. The other items are identical between the candidate specification record and the similarity specification record.

The candidate specification generation unit 191 sorts the received similarity specification records in descending order of similarity. The candidate specification generation unit 191 changes the items of similarity degree of each similarity specification record to a similarity rank, and allocates the same numerical value as the sort order to the similarity specification record. As a result, the candidate specification record sorted in the similarity rank is generated. The candidate specification records are stored in the candidate specification database 512 in the sorted order.

The candidate specification display unit 192 acquires all of the records or a predetermined higher number of records from the candidate specification database 512, deletes the items of the similarity order and the case number from each of the acquired records, and adds the candidate numbers. The candidate specification display unit 192 generates a prototype candidate selection page 360 from the changed candidate specification record, and transmits (outputs) the generated prototype candidate selection page 360 to the customer terminal 12, The order and the candidate number of the candidate specification record in the prototype candidate selection page 360 coincide with those in the similarity rank. The customer terminal 12 displays the received prototype candidate selection page 360.

When a request for a new design prototype (new item) is input to the prototype candidate selection page 360, the candidate specification display unit 192 receives the request from the customer terminal 12. The candidate specification display unit 192 acquires the required specification record from the required specification database 511, and generates a candidate specification record of the new case.

The candidate specification display unit 192 determines the values of the specification items (for example, shapes) which are insufficient in the new case request, and the values of the estimated cost and the estimated delivery date from the values of other candidate specification records. For example, in the priority item of the new case, a value of the highest similarity candidate specification record (candidate specification record of similarity rank 1) is used,

The candidate specification display unit 192 inserts the generated candidate specification record of the new case into the top of the candidate specification database 512 and the prototype candidate selection page 360. The candidate number is renumbered. When the new case can be open to the public, the candidate specification display unit 192 adds the candidate specification record whose cost has been reduced to the candidate specification record of the normal cost.

As shown in FIG. 20C, when a candidate number is selected as a prototype target in the prototype candidate selection page 360, the provisional specification generation unit 193 receives the candidate number selected from the customer terminal 12. The provisional specification generation unit 193 acquires the record of the received candidate number from the candidate specification database 512, generates a provisional specification record, and stores the generated provisional specification record in the provisional specification database 513. The provisional specification database 513 stores the record to be displayed on the design provisional specification output and approval input page 370A.

A format of the provisional specification record is the same as the record of the design provisional specification output and approval input page 370A shown in FIG. 9. The provisional specification record generated by the provisional specification generation unit 193 is identical with, for example, the record 371 of the design provisional specification output and an approval input page 370A.

The design interface unit 185 acquirers the provisional specification record from the provisional specification database 513 to generate the design provisional specification output and the approval input page 370A, and transmits the generated design provisional specification output and the approval input page 370A to the customer terminal 12. The customer terminal 12 displays the design provisional specification output and approval input page 370A. For example, in the design provisional specification output and approval input page 370A of FIG. 9, the record 371 is displayed. When receiving a denial of the customer for the displayed design preliminary specification output and approval input page 370A, the design interface unit 185 activates the required specification receiving unit 183.

Upon receiving the customer's approval for the displayed design provisional specification output, and approval input page 370A, the design interface unit 185 acquires the provisional, specification record from the provisional specification database 513 and extracts the items (for example, band, sensitivity, shape, and mounting form) of the sensor specification. The design interface unit 185 transmits the design request to the design division system 14 together with the designation of the values of the sensor specification items and the priority items. As a result, the design department can appropriately perform the design according to the required specification.

The design interface unit 185 changes the status of the provisional specification record in the provisional specification database 513 to, for example, “under design.” Upon receiving the request from the customer terminal 12 until receiving a response to the design request, the design interface unit 185 transmits the design provisional specification output and approval input page 370A indicating that the design is in progress. For example, a provisional specification record in which the status has been changed is indicated. The status of the provisional specification record may not been updated. As described later, the design interface unit 185 may calculate the estimated cost and delivery date in the design, and update the provisional specification record with those values.

The design interface unit 185 receives the values of the sensor specification items (for example, the band, the sensitivity, the shape, the installation form) in the present design trial together with a completion response from the design department system 14. The design interface unit 185 calculates the current values of the cost and the delivery date in the design by a predetermined method.

For example, the design interface unit 185 increases the cost and delivery date in the design according to the number of design trials . For example, the design cost is determined according to (0.1 M yen×trial number), and the delivery time is determined according to (0.1 Week×number of trials).

The design interface unit 185 updates the provisional specification record of the provisional specification database 513 based on the sensor specification acquired from the design department system 14 and the current values of the calculated cost and delivery date. The design interface unit 185 updates the status of the provisional specification record. The updated provisional

specification record is the same as the record 372 in the design provisional specification output and approval input page 370A of FIG. 9.

The design interface unit 185 generates the design provisional specification output and the approval input page 370A from the updated provisional specification record and transmits the generated design provisional specification output and the approval input page 370A to the customer terminal 12. The design provisional specification output and approval input page 370A promotes the selection of the design continuation or the design approval (completion) in the displayed specification.

Upon receiving an instruction of the design continuation (retry of design) from the customer for the design provisional specification output and approval input page 370A, the design interface unit 185 counts up the number of trials and requests the design department system 14

When the customer wishes to change the priority item, change the sensor specification, and son, a request change instruction is input to the design provisional specification output and approval input page 370A. Upon receiving the request change instruction, the design interface unit 185 activates the required specification receiving unit 183. The required specification input page 350A is transmitted to the customer terminal 120.

Upon receiving an instruction of the design completion (approval of design) from the customer, the design interface section 185 acquires the design data from, the design department system 14, and requests the manufacturing interface section 186 to start manufacturing the prototype. More specifically, the design interface unit 185 transmits the design data together with the approval of the design to the manufacturing interface unit 186. The design interface unit 185 updates the status of the provisional specification record of the provisional specification database 513, and further generates the design provisional specification output and approval input page 370A indicating the updated provisional specification record. The design provisional specification output and approval input page 370A is transmitted to the customer terminal 12 and presented to the customer.

As described above, the records of the design provisional specification output and approval input page 370A are the same as the provisional specification records in the provisional specification database 513. The provisional specification records change similarly to the records 371, 372, and 373 of the design provisional specification output and approval input page 370A, respectively.

As shown in FIG. 20D, upon receiving the approval and the design data, the manufacturing interface unit 186 transmits the design data and the manufacturing request for the prototype to the manufacturing department system 15. The manufacturing interface unit 186 waits for a response from the manufacturing department system 15.

The manufacturing interface section 186 updates the provisional specification record of the provisional specification database 513 according to the manufacturing request to the manufacturing department system 15. Further, upon receiving a request from the customer terminal 12, the manufacturing interface section 186 generates the manufacturing provisional specification output and approval input page 380 indicating the updated provisional specification record, and transmits the generated manufacturing provisional specification output and approval input page 380 to the customer terminal 12. The provisional specification record indicates that the status is “under manufacturing”.

The manufacturing department system 15 receives the values of the sensor specification items (for example, the band, the sensitivity, the shape, the installation form) in the current manufacturing trial together with the completion response of the manufacturing trial from the manufacturing department system 15. The manufacturing department system 15 calculates the current values of the cost and the delivery date in the manufacture by a predetermined method. The calculation method can be the same as the calculation method in the design.

The manufacturing interface unit 186 updates the provisional specification record of the provisional specification database 513 on the basis of the sensor specification acquired from the manufacturing department system 15 and the current values of the calculated cost and delivery date. The manufacturing interface unit 186 also updates the status of the provisional specification record. The updated provisional specification record is the same as the record 381 in the manufacturing provisional specification output and approval input page 380 of FIG. 10.

The manufacturing interface unit 186 generates the manufacturing provisional specification output and approval input page 380 from the updated provisional specification record, and transmits the generated manufacturing provisional specification output and approval input page 380 to the customer terminal 12. The manufacturing provisional specification output and approval input page 380 promotes the selection of the retrial of the manufacture or the approval (the completion of manufacture) of the manufactured prototype based on the displayed specification.

Upon receiving an instruction of the manufacturing retry from the customer to the manufacturing provisional specification output and approval input page 380, the manufacturing interface unit 186 counts up the number of trials and requests the manufacturing department system 15 to redesign.

When the customer wishes to change the priority item, change the sensor specification, and so on, the request change instruction is input to the manufacturing provisional specification output and approval input page 380. Upon receiving the request change instruction, the manufacturing interface unit 186 activates the required specification receiving unit 183. The required specification input page 350A is transmitted to the customer terminal 120.

Upon receiving an instruction to complete manufacture (approval of the prototype) and an instruction of evaluation from the customer, the manufacturing interface section 186 requests the evaluation interface unit 187 to evaluate the prototype. More specifically, the manufacturing interface unit 186 transmits the provisional specification record together with the approval of the prototype to the evaluation interface unit 187. The prototype is identified by the case number.

The evaluation interface unit 187 designates the case number and request the evaluation department system 16 to perform an evaluation. A person in charge of the evaluation department obtains the prototype from the manufacturing department and performs the evaluation. The evaluation interface unit 187 receives the evaluation result of the prototype from the evaluation department system 16. The evaluation interface unit 187 generates a result specification record based on the provisional specification record and the evaluation result, and stores the generated, result specification record in the result specification database 514. The result specification record example is a record of the evaluation result output page 390 shown in FIG. 11.

The evaluation interface unit 187 generates an evaluation result output page 390 from the result specification record and transmits the generated evaluation result output page 390 to the customer terminal 12, The customer terminal 12 presents the evaluation result, output page 390 to the customer in the input and output device 126.

One of the sensor evaluation methods is to use a measurement environment (drive circuit, evaluation circuit) and the other method is to evaluate the operation of the sensor installed in the customer's measurement target. The evaluation method is appropriately selected according to a request from the customer or the device.

When the customer wishes to change the priority item, change the sensor specification, and so on for the evaluation result, the request change instruction is input to the evaluation result output page 390. Upon receiving the request change instruction, the evaluation interface unit 187 activates the required specification receiving unit 183. The required specification input page 350A is transmitted to the customer terminal 120.

The present invention is not limited to the embodiments described above, but includes various modifications. For example, in the above mentioned embodiments, in order to easily understand the present invention, the specific configurations are described. However, the present invention does not always provide all of the configurations described above. Also, a part of one configuration example can be replaced with another configuration example, and the configuration of one embodiment can be added with the configuration of another embodiment. Also, in a part of the respective configuration examples, another configuration can be added, deleted, or replaced.

Also, parts or all of the above-described respective configurations, functions, processors, processing means may be realized, for example, as an integrated circuit, or other hardware. Also, the above respective configurations and functions may be realized by allowing the processor to interpret and execute programs for realizing the respective functions. That is, the respective configurations and functions may be realized by software. The information on the program, table, and file for realizing the respective functions can be stored in a storage device such as a memory, a hard disc, or an SSD (solid state drive), or a storage medium such as an IC card, an SD card, or a DVD. Also, the control lines and the information lines necessary for description are illustrated, and all of the control lines and the information lines necessary for products are not illustrated. In fact, it may be conceivable that most of the configurations are connected to each other.

### LIST OF REFERENCE SIGNS

10, prototype receiving server; 12, customer terminal; 13 device introduction terminal; 14, design department system; 15, manufacturing department system; 16, evaluation department system; 102a and 102b, interface; 103, CPU; 104, main memory; 105, auxiliary memory; 107, communication path; 122, interface; 123, CPU; 124 main memory; 125, auxiliary memory; 126, input and output device, 127 communication path

1. A device design receiving system that receives a request for designing a device, the system, comprising:
old case specification information indicating a specification of an old case of a device design;
a receiving unit that receives a required specification for a device from a user input and output device;
a search unit that searches a case similar to the required specification in the old case specification information;
an output unit that outputs the case similar to the required specification found in the old case specification information to the user input and output device; and
a design interface unit that calculates a specification of a design result of the device according to the required specification for an unauthorized input for the similar case from the user input, and output device, or transmits a request for designing the device according to the required specification to an external design system, and outputs the design result of the device calculated or received, from the design system to the user input and output device.

2. The device design receiving system according to claim 1, wherein
the design interface unit recalculates the specification of the design result of the device according to the required specification in response to the unauthorized input to the specification of the design result from the user input and output device, or transmits a request for retrying the design of the device to the design system, and outputs the specification of the result of the recalculation or retrial to the user input and output device.

3. The device design receiving system according to claim 2, further comprising a manufacturing interface unit that transmits a request for manufacturing the device according to the result of the retrial to an external manufacturing system in response to an input of approval to the specification of a result of the retrial from the user input and input device, and outputs the specification of the manufactured device to the user input and output device.

4. The device design receiving system according to claim 1, further comprising read-made specification information indicating the specification of the ready-made product, wherein
the search unit further searches the case similar to the required specification in the ready-made specification information.

5. The device design receiving system according to claim 3, wherein
the design interface unit calculates the past costs for each step in the design of the device, and outputs progress information on the costs of the device design in the design result and the retrial result to the user input and output device.

6. The device design receiving system according to claim 5, wherein
the receiving unit receives an instruction for permission or prohibition of disclosure of information on the design of the required specification from the user input and output device, and
the design interface unit determines a method of calculating the costs on the basis of the instruction for the permission or prohibition.

7. The device design receiving system according to claim 3, wherein
the manufacturing interface unit transmits a request for retrial of manufacturing of the device to the manufacturing system in response to an unauthorized input from the user input and output device to the specification of the manufactured device.

8. The device design receiving system according to claim 3, wherein
the manufacturing interface unit calculates the past costs for each step in the manufacturing of the device by a predetermined calculation method, and outputs the cost progress information in the designing and manufacturing of the device, together with the specification of the manufactured device.

9. The device design receiving system according to claim 1, wherein
the receiving unit outputs a first interface image for prompting selection of one request level from a predetermined request level to the user input and output device, and outputs a second interface image including an input item corresponding to the request level selected in the first interface image to the user input and output device.

10. The device design receiving system according to claim 1, wherein
the receiving unit receives designation of a priority item in the required specification from the user input and output device, and
the search unit selects the similar case based on a value of the priority item.

11. The device design receiving system according to claim 1, further comprising an evaluation interface unit that outputs an evaluation result of the manufactured device to the user input and output device, wherein
the receiving unit receives the changed required specification from the user input and output device after outputting the evaluation result.

12. The device design receiving system according to claim 1, wherein
the user input and output device displays one or more of a specification of a case similar to the required specification, and a cost and a delivery date of the specification of the design result of the device.

13. A method of processing a request for designing a device by a device design receiving system,
the device design receiving system stores old case specification information indicating a specification of an old case of a device design;
the method causing the device design receiving system to execute:
receiving a required specification for a device from a user input and output device;
searching a case: similar to the required specification in the old case specification information;
outputting the case similar to the required specification found in the old case specification information to the user input and output device; and
calculating a specification of a design result of the device according to the required specification for an unauthorized input for the similar case from the user input and output device, or transmitting a request for designing the device according to the required specification to an external design system, and outputting the design result of the device calculated or received from the design system to the user input and output device.
